(19) United States
(12) Patent Application Publication
(10) Pub. No.: US 2009/0320539 A1
(43) Pub. Date: Dec. 31, 2009

(54) LOCK ASSEMBLY CAPABLE OF RECORDING THE NUMBER OF TIMES OF UNLOCKING OPERATION

(76) Inventor: Yao-Kun Yang, Chang Hua City (TW)

Correspondence Address: BROWDY AND NEIMARK, P.L.L.C.;624 NINTH STREET, NW, SUITE 300, WASHINGTON, DC, 20001-5303, US

(21) Appl. No.: 12/253,293

(22) Filed: Oct. 17, 2008

(30) Foreign Application Priority Data
Jun. 30, 2008 (TW) 97136741

(51) Int. Cl. E05B 37/02

(52) U.S. Cl. 70/312

(57) ABSTRACT

A lock assembly includes a housing, a shackle having a pivotal portion, which is disposed in the housing and axially moveable and pivotable, and a free end insertable into a top hole of the housing, a latch movably disposed in the housing and engagable with the pivotal portion or a free end of the shackle, and a lock unit disposed in the housing and having a block portion. When the lock unit is unlocked, the block portion allows a disengaging movement of the latch from the insertion groove such that the shackle can be move upwards to start the counter. When the lock unit is locked, the block portion prohibits the disengaging movement of the latch from the insertion groove such that the shackle can't be moved upwards, and the counter can't be started.

### BACKGROUND OF THE INVENTION

1. Field of the Invention

The present invention relates generally to locks and more specifically, to a lock assembly including a counter to count the number of times that the lock assembly is unlocked.

2. Description of the Related Art

Conventional padlocks generally include two types, i.e. a key controlled type, which needs a correct key to unlock it, and a combination controlled type, which needs a correct permutation of the numbers or symbols to unlock it. Both of the key controlled type padlocks and the combination controlled type padlocks are used widely to secure a door, drawer, or container, thereby restricting access to the area or the property enclosed.

The conventional padlocks can prevent people who don't have the key or don't know the permutation of the numbers or symbols from unlocking it, but can't keep people who is capable of acquiring the key or the permutation of the numbers or symbols from unlocking it, such as the home care for the elderly, the servant, or the storekeeper. If these people unlock the padlocks without authorization to steal the valuables from the drawer, the room, or the storehouse and then lock it, the family members or other storekeepers may be aware of something stolen after a long time, or don't even know about the facts. Under this circumstance, these unworthy people may steal the valuables over and over again, thereby causing huge loss for the family or the storehouse.

### SUMMARY OF THE INVENTION

The present invention has been accomplished in view of the above-noted circumstances. It is therefore one objective of the present invention to provide a lock assembly, which has a counter to count and record the number of times of unlocking operation.

To achieve this objective of the present invention, the lock assembly comprises a housing, a shackle having a pivotal portion, which passes through a first top hole of the housing into an accommodation chamber of the housing and is axially moveable and pivotable relative to the housing, and a hook portion integrally connected with the pivotal portion and provided with a free end insertable into a second top hole of the housing by means of the axial movement of the pivotal portion, at least one latch movably disposed in the accommodation chamber of the housing and engagable with an insertion groove provided by at least one of the pivotal portion and the free end of the hook portion of the shackle, a counter disposed in the accommodation chamber of the housing, and a lock unit disposed in the accommodation chamber of the housing and having a block portion.

When the lock unit is unlocked, the block portion allows a disengaging movement of the latch from the insertion groove such that the pivotal portion of the shackle can be axially moved to allow the free end of the hook portion of the shackle to leave the second top hole and to start the counter. When the lock unit is locked, the block portion prohibits the disengaging movement of the latch from the insertion groove such that the pivotal portion of the shackle can't be axially moved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a partially cutaway schematic drawing of a lock assembly according to a first preferred embodiment of the present invention, showing that the lock unit is locked;

FIG. 2 is a lateral and partially cutaway view of FIG. 1;

FIG. 3 is another partially cutaway schematic drawing of the lock assembly according to the first preferred embodiment of the present invention, showing that the lock unit is unlocked;

FIG. 4 is a lateral and partially cutaway view of FIG. 3;

FIG. 5 is a partially cutaway schematic drawing of a lock assembly according to a second preferred embodiment of the present invention, showing that the lock unit is locked, and

FIG. 6 is another partially cutaway schematic drawing of the lock assembly according to the second preferred embodiment of the present invention, showing that the lock unit is unlocked.

### DETAILED DESCRIPTION OF THE INVENTION

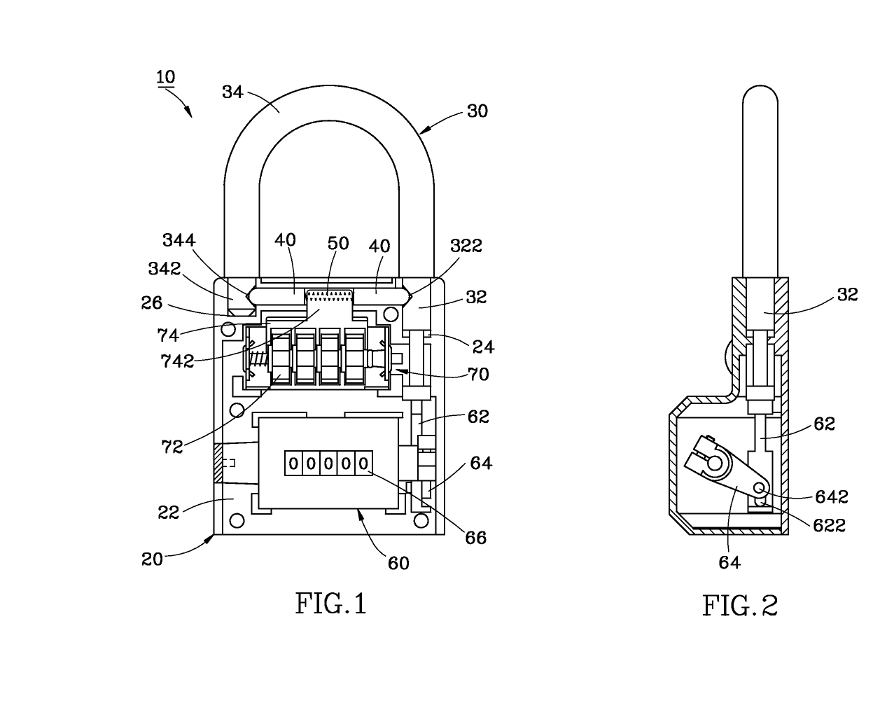

As shown in FIGS. 1 and 2, a lock assembly 10 in accordance with a first preferred embodiment of the present invention comprises a housing 20, a shackle 30, two latches 40, an elastic member 50, a counter 60, and a lock unit 70.

The housing 20 has an accommodation chamber 22, a first top hole 24 in communication with the accommodation chamber 22, and a second top hole 26 in communication with the accommodation chamber 22.

The shackle 30 has a pivotal portion 32 and a hook portion 34 integrally connected with the pivotal portion 32. The pivotal portion 32 passes through the first top hole 24 of the housing 20 into the accommodation chamber 22 of the housing 20 and is axially moveable and pivotable relative to the housing 20. The hook portion 34 is provided with a free end 342 insertable into the second top hole 26 of the housing 20 by means of the axial movement of the pivotal portion 32. The pivotal portion 32 and the free end 342 of the hook portion 34 each have an insertion groove 322 or 344.

The latches 40 are disposed in the accommodation chamber 22 of the housing 20 and horizontally moveable relative to the housing 20 such that the latches 40 can be engaged with or disengaged from the insertion grooves 322 and 344 respectively.

The elastic member 50 is disposed between the latches 40, having two ends respectively stopped against the latches 40 for providing an elastic force to push the latches 40 toward the insertion grooves 322 and 344.

The counter 60 is mounted in the accommodation chamber 22 of the housing 20, including a plurality of counting wheels 66, a first driving member 62 with an elongated slot 622, and a second driving member 64 having a bottom pivotally connected with the counting wheels 66 and a top with a shaft 642 inserted into the elongated slot 622. When an external force presses the first driving member 62, the second driving member 64 stays stationary, such that the counting wheels 66 won't be driven to rotate by the second driving member 64. When the external force is released, the second driving member 64 can be rotated counterclockwise by means of a torque spring (not shown) to drive the first driving member 62 to move upwards and to drive the counting wheels 64 to rotate for counting. Since the counter 60 is a well known prior art that can be easily accomplished by a person skill in the art or can be easily obtained from market or manufacturer, the detailed structure thereof won't be necessarily described hereunder.

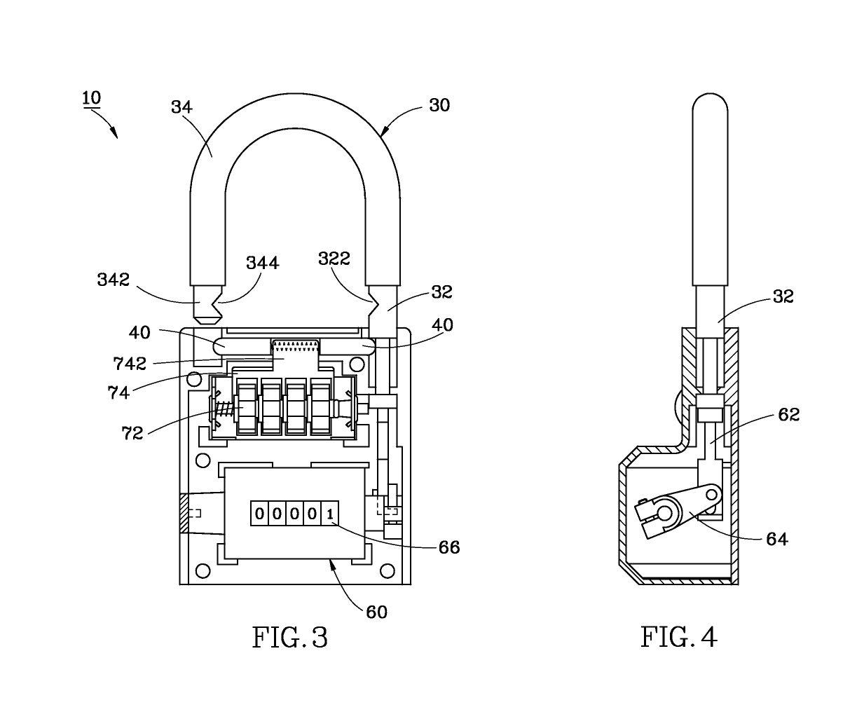

The lock unit 70 is embodied as a combination lock in this preferred embodiment, including a plurality of numbered wheels 72 and a moveable plate 74 controllable by the numbered wheels 72 to move relative to the latches 40 and provided with a block portion 742. When the numbered wheels 72 show a wrong number permutation, the lock unit 70 is locked, as shown in FIGS. 1 and 2. At this time, the block portion 742 of the movable plate 74 blocks between the latches 40 to force the latches 40 to be engaged with the insertion groove 322 of the pivotal portion 32 and the insertion groove 344 of the free end 342 of the hook portion 34 of the shackle 30 such that the shackle 30 can't be pulled upwards, resulting in that the pivotal portion 32 of the shackle 30 presses the first driving member 62 of the counter 60, thereby making the second driving member 64 stay stationary because of the restriction of the elongated slot 622 of the first driving member 62. When the numbered wheels 72 show a correct number permutation, the lock unit 70 is unlocked, as shown in FIGS. 3 and 4. At this time, the movable plate 74 is biased to force the block portion 742 to be staggered with the latches 40 such that the latches 40 can be disengaged from the insertion grooves 322 and 344 to enable the shackle 30 to be pulled upwards, resulting in that the pivotal portion 32 of the shackle 30 can be axially moved to drive the free end 342 of the hook portion 34 to leave the second top hole 26 of the housing 20, and to release the pressure exerting on the first driving member 62 of the counter 60, thereby allowing the second driving member 64 to be rotatable for starting the counter 60.

By means of aforesaid design, when the lock assembly 10 is locked, as shown in FIGS. 1 and 2, the shackle 30 can't be pulled upwards due to the restriction of the latches 40, and the counter 60 can't be stared because the first driving member 62 of the counter 60 is pressed by the pivotal portion 32 of the shackle 30. When somebody rotates the numbered wheels 72 to show the correct number permutation with or without authorization, as shown in FIGS. 3 and 4, the latches 40 can be movable relative to the housing 20 to be disengaged from the insertion grooves 322 and 344 because the block portion 742 of the movable plate 74 and the latches 40 are staggered, such that the shackle 30 can be pulled upwards to unlock the lock assembly 10. At the time of unlocking the lock assembly 10, the second driving member 64 of the counter 60 can drive the counting wheels 66 to rotate because the pivotal portion 32 of the shackle 30 releases the pressure exerting on the first driving member 62 of the counter 60, thereby counting the number of times that the lock assembly 10 is unlocked. As a result, even though the lock assembly 10 is locked again, the counter 60 won't return to zero and a user of the lock assembly 10 of the present invention can be immediately aware that the lock assembly 10 had been unlocked by someone through the counter 60.

The lock assembly can be made with various kinds of design on the basis of the spirit of the present invention. For example, the pivotal portion of the shackle and the first driving member of the counter can be made integrally, or the length of the pivotal portion of the shackle can be increased to an extent that can be connected to the second driving member of the counter.

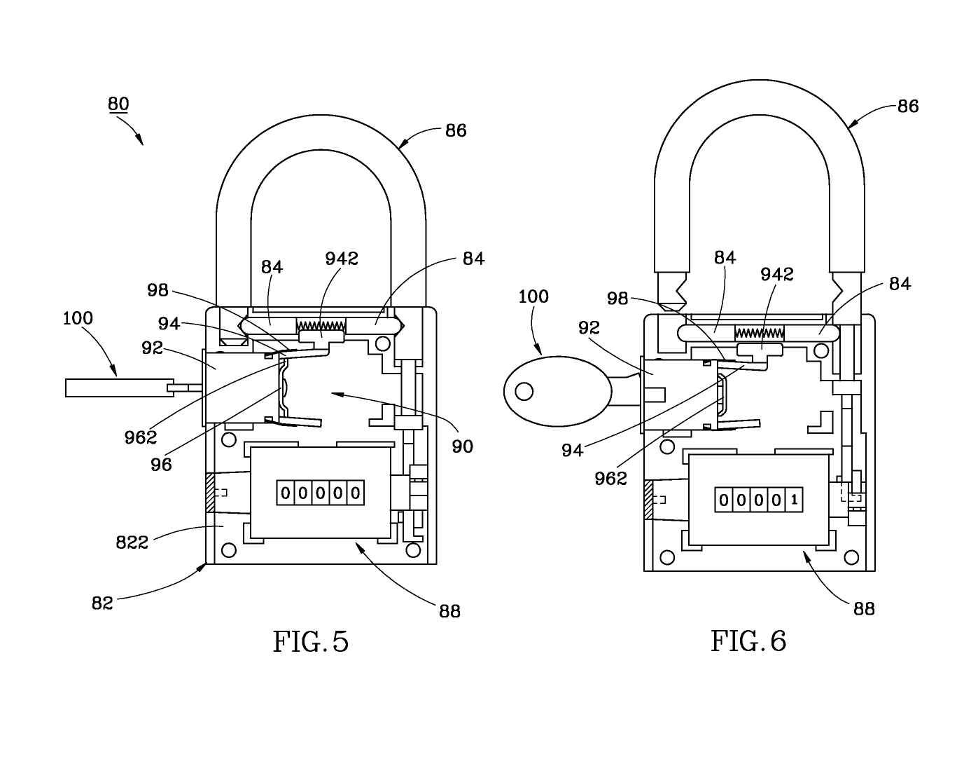

Besides, the lock unit is not limited to the above-mentioned embodiment of the present invention. FIG. 5 shows a lock assembly 80 in accordance with a second preferred embodiment of the present invention. In this embodiment, the lock unit 90 is a pin tumbler lock, including a plug 92 rotatably disposed in the accommodation chamber 822 of the housing 82, an arm 94 extending from the plug 92, a rotatable member 94 mounted to the plug 92, and an elastic strip 98 mounted to the plug 92.

When the plug 92 is locked, as shown in FIG. 5, an urging portion 962 of the rotatable member 96 is stopped against the arm 94 to force a block portion 942 of the arm 94 to move into a space defined between the latches 84, such that the shackle 86 can't be pulled upwards, resulting in that the counter 86 can't be stared. When somebody uses a key 100 to unlock the lock unit 90, as shown in FIG. 6, the urging portion 962 of the rotatable member 96 is moved away from the arm 94 such that the arm 94 is pushed by the elastic strip 98 to force the block portion 942 of the arm 94 to move out of the space defined between the latches 84, thereby allowing the shackle 86 to be pulled upwards, thereby starting the counter 88.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A lock assembly comprising:
a housing having an accommodation chamber, a first top hole in communication with said accommodation chamber, and a second top hole in communication with said accommodation chamber;
a shackle having a pivotal portion, which passes through said first top hole into said accommodation chamber and is axially moveable and pivotable relative to said housing, and a hook portion integrally connected with said pivotal portion and provided with a free end insertable into said second top hole by means of the axial movement of said pivotal portion, at least one of said pivotal portion and said free end of said hook portion having an insertion groove;
at least one latch movably disposed in said accommodation chamber of said housing and engagable with said insertion groove;
a counter disposed in said accommodation chamber of said housing; and
a lock unit disposed in said accommodation chamber of said housing and having a block portion, which allows a disengaging movement of said latch from said insertion groove such that said pivotal portion of said shackle can be axially moved to allow said free end of said hook portion of said shackle to leave said second top hole and to start said counter when said lock unit is unlocked, and which prohibits the disengaging movement of said latch from said insertion groove such that said pivotal portion of said shackle can't be axially moved when said lock unit is locked.

2. The lock assembly as claimed in claim 1, wherein each of said pivotal portion of said shackle and said free end of said hook portion of said shackle has one said insertion groove; the lock assembly comprises two said latches respectively engaged with said insertion grooves of said pivotal portion of said shackle and said free end of said hook portion of said shackle, and an elastic member having two ends respectively stopped against said latches.

3. The lock assembly as claimed in claim 2, wherein said lock unit includes a plurality of numbered wheels and a movable plate having said block portion; said moveable plate is controllable by said numbered wheels to move relative to said latches.

4. The lock assembly as claimed in claim 1, wherein said counter includes a plurality of counting wheels, a first driving member, and a second driving member pivotally connected with said counting wheels and connected with said first driving member; when said lock unit is locked, said pivotal portion of said shackle presses said first driving member such that said second driving member stays stationary and can't drive said first driving member to move along an axial direction of said first top hole of said housing, and can't drive said counting wheels to rotate; when said lock unit is unlocked, the said pivotal portion of said shackle releases the pressure exerting on said first driving member such that said second driving member is pivotable to drive said first driving member to axially move and to drive said counting wheels to rotate.

5. The lock assembly as claimed in claim 4, wherein said first driving member has an elongated slot and said second driving member has a shaft inserted into said elongated slot.

6. The lock assembly as claimed in claim 1, wherein said lock unit includes a plug rotatably disposed in said accommodation chamber, an arm extending from said plug and having said block portion, a rotatable member mounted to said plug and having an urging portion, and an elastic strip mounted to said plug and stopped against said arm; when said lock unit is unlocked, said urging portion of said rotatable member is moved away from said arm such that said block portion of said arm is forced by said elastic strip to unblock said latch; when said lock unit is locked, said urging portion of said rotatable member is stopped against said arm to enable said block portion of said arm to block said latch.
